(19) United States
(12) Patent Application Publication
(10) Pub. No.: US 2009/0286003 A1
(43) Pub. Date: Nov. 19, 2009

(54) METHOD OF COATING A TURBINE ENGINE COMPONENT USING A LIGHT CURABLE MASK

(76) Inventors: George H. Reynolds, Sanford, ME (US); Richard M. Gregoire, Wells, ME (US); James J. Gagnon, Lebanon, ME (US); James J. Foster, Wells, ME (US); Richard J. Worell, Sanford, ME (US); John J. Quint, Lyman, ME (US); David M. Larochelle, Hollis Center, ME (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/119,534

(22) Filed: May 13, 2008

(51) Int. Cl. C08J 7/04

(52) U.S. Cl. 427/510

(57) ABSTRACT

A method of coating a turbine engine component involves providing the turbine engine component with a first area and a second area. The first area neighbors the second area. A cover is disposed over the first area of the turbine engine component. The second area of the turbine engine component is coated with a first coating curable from exposure to a light. The second area of the turbine engine component is exposed to light resulting in the curing of the first coating. The cover is removed from the first area. The first area of the turbine engine component is then sprayed with a second coating different from the first coating.

### BACKGROUND OF THE INVENTION

This invention relates to a method of coating a turbine engine component.

A turbine engine component is generally subjected to extreme temperatures and conditions. To preserve the turbine engine component, portions of the turbine engine component are provided with a protective coating. This coating is typically applied by a thermal sprayer using a plasma torch.

During this coating process, other portions of the turbine engine component generally remain uncoated. For example, associated shrouds and vanes of a stator assembly are generally uncoated. The vanes and shrouds are accordingly masked against the coating.

At least some known techniques for masking the turbine engine component are time consuming and potentially environmentally hazardous. For example, some known techniques include taping portions of the turbine engine component and then dipping the taped component in a toluene based masking material, which is a volatile organic compound potentially harmful to the environment. The masking material is then cured in an oven while the tape is manually removed with a tool. Additional masking material may be applied. The turbine engine component is then ready to be coated with a protective coating applied by a thermal sprayer. This process is environmentally unsafe, time consuming and labor intensive.

A need therefore exists for an improved coating technique that is more efficient and environmentally safer.

### SUMMARY OF THE INVENTION

A method of coating a turbine engine component involves providing the turbine engine component with a first area and a second area. The first area neighbors the second area. A cover is disposed over the first area of the turbine engine component. The second area is then coated with a first coating curable from exposure to a light. The second area is exposed to the light resulting in a cured first coating. The cover is then removed from the first area. The first area of the turbine engine component is sprayed with a second coating different from the first coating.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 illustrates an exemplary system and method of coating a turbine engine component with.

FIG. 2 illustrates the turbine engine component of FIG. 1 exposed to light.

FIG. 3 illustrates an application of a second coating on the turbine engine component.

FIG. 4 illustrates a curing of the second coating on the turbine engine component.

### DETAILED DESCRIPTION OF THE PREFERRED EMBODIMENT

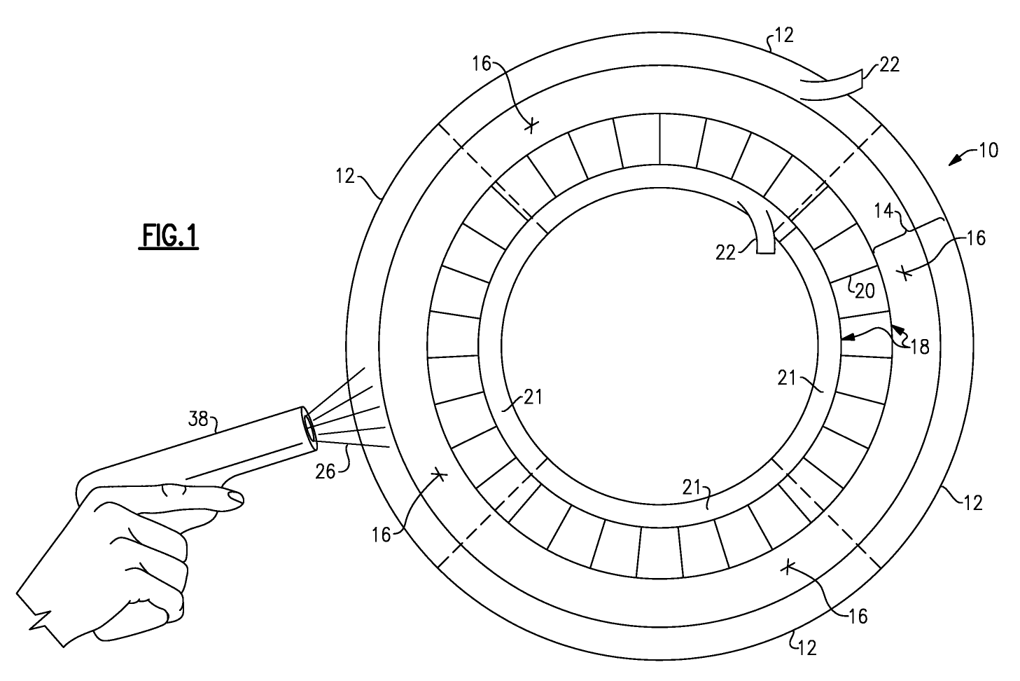

With reference to FIG. 1, there is shown an exemplary turbine engine component 10 such as, but not limited to, a stator assembly that includes stator segments 12. Turbine engine component 10 has first area 14, which is a flange area having a channel 16. Turbine engine component 10 also includes a second area 18 including vanes 20 and associated inner and outer shrouds. The first area 14 may include a protective coating that facilitates reducing wear against various conditions experienced by turbine engine component 10. A protective coating may also be applied to inner circumferential areas 21, e.g., the ringed area extending inwardly of second area 18. However, predetermined uncoated areas such as, but not limited to, second area 18 may be masked from the protective coating such that the area remains uncoated.

The exemplary method for selectively coating turbine engine component 10 will now be explained with reference to FIGS. 1-4. As shown in FIG. 1, first area 14 and inner circumferential area 21 is covered by cover 22 such as, but not limited to, a masking tape. Following covering/masking of first area 14 and inner circumferential area 21, masking sprayer 38, such as a hand sprayer, applies a first coating 26 over second area 18 to cover vanes 20 as well as associated inner and outer shrouds (not shown). First coating 26 is an ultraviolet light curable mask, such as provided by Dymax under the trademark Dymax 717R™.

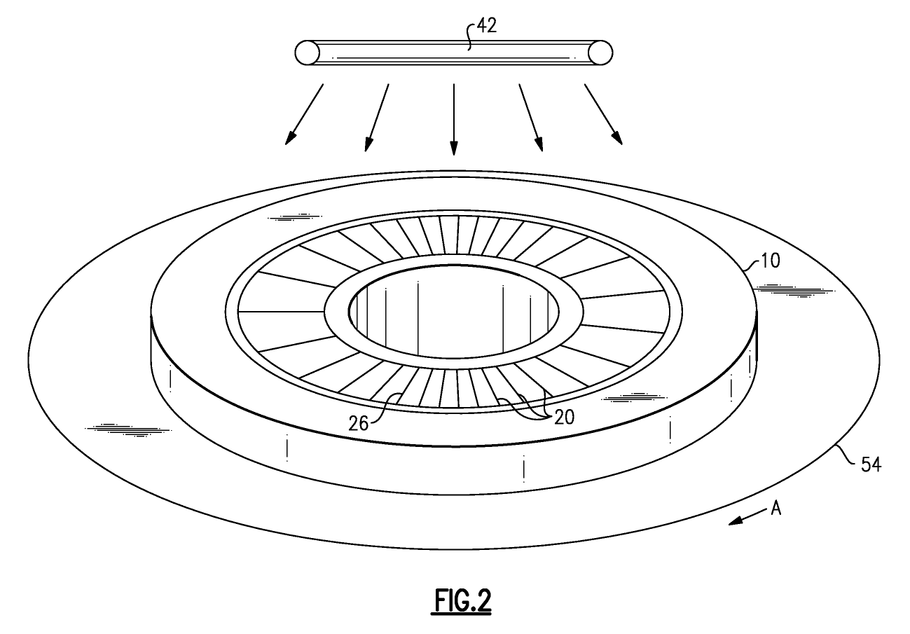

With reference to FIG. 2, turbine engine component 10 is then placed on turn table 54, which rotates in the direction of arrow A. Ultraviolet lamp 42 is activated, causing first coating 26 to cure. Once cured, cover 22 is removed from first area 14 and inner circumferential area 21 by tool.

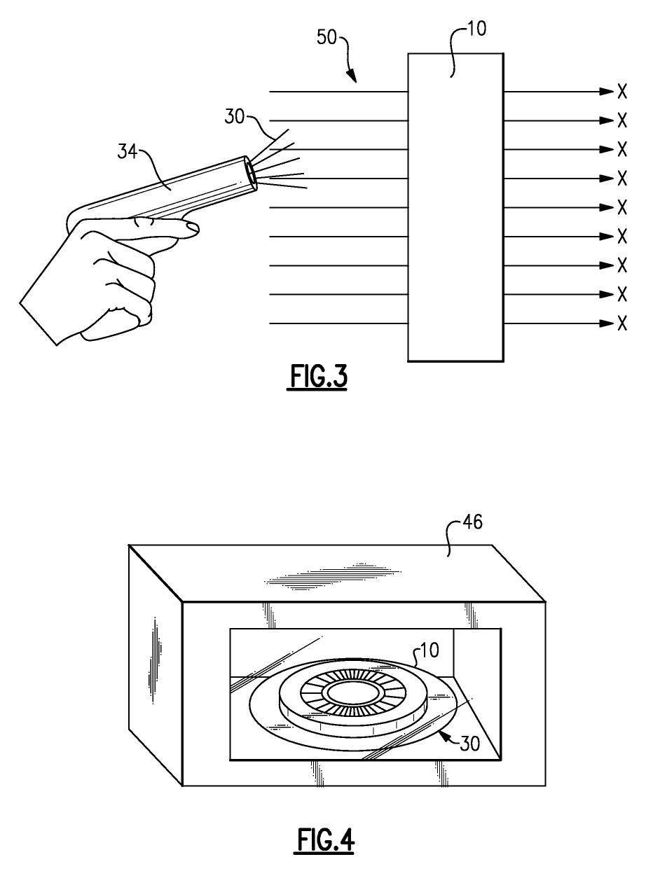

With reference to FIG. 3, second coating 30 is applied to turbine engine component 10 by thermal sprayer 34 such as, but not limited to, a plasma torch sprayer. Second coating 30 is a heat curable protective coating, which facilitates reducing wear caused by various heat and environment conditions experienced by turbine engine component 10 under engine operating conditions. Thermal sprayer 34 sprays second coating 30 generally along arrow X, which represents an anticipated gas path of air 50 through turbine engine component 10. This technique facilitates depositing second coating 30 in the areas exposed to the gas path of turbine engine component 10.

With reference to FIG. 4, following application of second coating 30, turbine engine component 10 is then placed in oven 46 and baked at a predetermined temperature of about 900° F. (±50° F.) or approximately 482° C. (±10° C.). This temperature range is both sufficient to cure second coating 30 as well as burn off first coating 26. Compared to known coatings methods, the exemplary coating system and method allow turbine engine component 10 to be quickly and easily coated. Also, the technique eliminates the use of toluene based masks that can be hazardous to health and the environment.

The foregoing description shall be interpreted as illustrative and not in any limiting sense. A worker of ordinary skill in the art would recognize that certain modifications would come within the scope of this invention. For that reason, the follow claims should be studied to determine the true scope and content of this invention.

We claim:

1. A method of coating a turbine engine component, comprising the steps of:
a) providing the turbine engine component having a first area and a second area, the first area neighboring the second area;
b) disposing a cover over the first area of the turbine engine component;
c) coating the second area of the turbine engine component with a first coating curable from exposure to a light;
d) exposing the second area of the turbine engine component to the light and thereby curing the first coating;
e) removing the cover from the first area; and
f) spraying the first area of the turbine engine component with a second coating different from the first coating.

2. The method of claim 1 including the step of:
g) curing the second coating, wherein curing the second coating removes the first coating.

3. The method of claim 2 wherein curing the second coating and removing the first coating comprises heating the first coating and the second coating at a temperature sufficient to cure the second coating and sufficient to burn off the first coating.

4. The method of claim 1 wherein the second coating is curable by exposure to heat.

5. The method of claim 1 wherein the second coating facilitates reducing the turbine engine component from wear.

6. The method of claim 1 wherein the first coating is curable by ultraviolet light.

7. The method of claim 1 wherein the cover includes a tape.

8. The method of claim 1 wherein spraying the first area comprises directing a spray of the first coating along an anticipated gas path of air through the turbine engine component.

9. The method of claim 1 wherein the turbine engine component is a stator segment.

10. The method of claim 9 wherein the second area encompasses a vane of the stator segment.

11. A method of coating a turbine engine component, comprising the steps of:
a) providing the turbine engine component having a first area and a second area, the first area neighboring the second area;
b) disposing a cover over the first area of the turbine engine component;
c) spraying the second area of the turbine engine component with a first coating curable from exposure to a light;
d) exposing the second area of the turbine engine component to the light and thereby curing the first coating;
e) removing the cover from the first area; and
f) spraying the first area of the turbine engine component with a second coating curable from heat.

12. The method of claim 11 including the step of:
g) curing the second coating, wherein curing the second coating removes the first coating.

13. The method of claim 12 wherein curing the second coating and removing the first coating comprises heating the first coating and the second coating at a temperature sufficient to cure the second coating and sufficient to burn away the first coating.

14. The method of claim 11 wherein the second coating facilitates reducing the turbine engine component from wear.

15. The method of claim 11 wherein the first coating is curable by exposure to ultraviolet light.

16. The method of claim 11 wherein the cover includes a tape.

17. The method of claim 11 wherein spraying the first area comprises directing a spray of the first coating along an anticipated gas path of air through the turbine engine component.

18. The method of claim 11 wherein the turbine engine component is a stator segment.

19. The method of claim 18 wherein the second area encompasses a vane of the stator segment.

20. A system for coating a part, comprising:
a sprayer for applying a protective coating on a part;
a masking sprayer for applying an ultraviolet light curable coating on the part;
an ultraviolet light source for curing the part; and
an oven for removing the ultraviolet light curable coating and curing the protective coating.
